(19) United States
(12) Patent Application Publication
(10) Pub. No.: US 2014/0074694 A1
(43) Pub. Date: Mar. 13, 2014

(54) CASINO CAGE AUTOMATION

(71) Applicants: ATTA H. MATEEN, EDEN PRAIRIE, MN (US); JOHN STEELY, LA CRESCENTA, CA (US)

(72) Inventors: ATTA H. MATEEN, EDEN PRAIRIE, MN (US); JOHN STEELY, LA CRESCENTA, CA (US)

(21) Appl. No.: 13/726,178

(22) Filed: Dec. 23, 2012

Related U.S. Application Data
(60) Provisional application No. 61/698,465, filed on Sep. 7, 2012.
(60) Provisional application No. 61/708,536, filed on Oct. 1, 2012.

(51) Int. Cl. G07F 17/32; G06Q 20/04

(52) U.S. Cl. CPC G07F 17/3246; G06Q 20/04
USPC 705/39; 235/379

(57) ABSTRACT

An embodiment of a casino cage method includes using a processing unit, providing cashier transaction options for responding to a request for funds via a graphical-user-interface, the cashier transaction options comprising one or more of cashing a check, cashing casino chips, redeeming a casino ticket, accessing bank account funds, and providing a cash advance. The method further includes receiving a cashier's selection of one or more of the transaction options, and using the graphical-user-interface, displaying at least one bill denomination capable of being disbursed using a cash recycler and a quantity of the at least one bill denomination to be disbursed. The method further includes receiving the cashier's selection of at least one preferred bill denomination and a quantity of each of the at least one preferred bill denominations, and transmitting a request to automatically disburse cash from the cash recycler.

### CROSS REFERENCE TO RELATED APPLICATION

This application claims the benefit of U.S. Provisional Application No. 61/698,465, filed on Sep. 7, 2012, and U.S. Provisional Application No. 61/708,536, filed on Oct. 1, 2012, each of which are hereby incorporated by reference in their entirety.

### BACKGROUND

1. Field of the Invention

The present invention relates to casino methods and systems, and in particular to casino cage automation.

2. Description of the Related Art

Conventional systems for casino cages typically involve use of a manual cash drawer by a casino cashier to provide funds for converting chips to cash. Conventional systems may also involve manual generation of transaction records by cashiers using pen and paper as each transaction takes place. In addition, the cashier may be required to physically count all funds that are received or disbursed. As part of the casino's management, manual operations performed by a cashier is monitored via a security camera so that amounts requested and provided can be verified at a later time. At the end of the day, the records prepared by the cashier must then be reconciled with the funds remaining in the manual cash drawer. Such conventional systems require considerable employee time to use, and require substantial time and effort to verify. Accordingly, improvements may be made in conventional casino systems.

### SUMMARY

In an embodiment, a casino cage method includes, using a processing unit, providing cashier transaction options for responding to a request for funds via a graphical-user-interface, the cashier transaction options comprising one or more of cashing a check, cashing casino chips, redeeming a casino ticket, accessing bank account funds, and providing a cash advance. The method further includes receiving a cashier's selection of one or more of the transaction options, and using the graphical-user-interface, displaying at least one bill denomination capable of being disbursed using a cash recycler and a quantity of the at least one bill denomination to be disbursed. The method further includes receiving the cashier's selection of at least one preferred bill denomination and a quantity of each of the at least one preferred bill denominations, and transmitting a request to automatically disburse from the cash recycler the selected quantity of each of the one or more selected bill denominations.

The method may include verifying authorization to transfer funds when the selected transaction option is one of cashing a check, redeeming a casino ticket, and obtaining a cash advance. The method may also include logging transactions performed using the system with respect to a login identifier, and generating a report of transactions performed with respect to the login identifier. The cashier transaction options may include each of cashing a check, cashing casino chips, redeeming a casino ticket, accessing bank account funds, and providing a cash advance.

In some embodiments, the method includes generating a proposed quantity of bill denominations to fulfill the request for funds in accordance with a predetermined function. The predetermined function may include one of using the least number of bills capable of fulfilling the request for funds, providing a requested quantity of a preferred bill denomination and automatically selecting a remaining set of bills to minimize the number of bills disbursed, and using the least number of bills available in the cash recycler to satisfy the request for funds.

The method of claim 1 may include receiving a customer's identification number from a card reader, and logging transactions performed using the system with respect to the customer's identification number and the login identifier. The method may further include video recording operations performed by a cashier while using the system. A hotkey may be assigned to a particular bill denomination, and the cashier selection of a bill denomination may be received after the hotkey is pressed. In some embodiments, the quantity of the selected bill denomination to be disbursed corresponds to the number of times the hotkey is pressed. In other embodiments, the quantity of the selected bill denomination to be disbursed is selected using numeric key entries after the bill denomination has been selected.

In an embodiment, a computer-readable medium includes instructions that, when executed by a processing unit, cause the processing unit to performing the operation of, using a processing unit, providing cashier transaction options for responding to a request for funds via a graphical-user-interface, the cashier transaction options comprising one or more of cashing a check, cashing casino chips, redeeming a casino ticket, accessing bank account funds, and providing a cash advance. The processing unit is further caused to perform the operation of receiving a cashier's selection of one or more of the transaction options, and using the graphical-user-interface, displaying at least one bill denomination capable of being disbursed using a cash recycler and a quantity of the at least one bill denomination to be disbursed. The processing unit is further caused to perform the operation of receiving the cashier's selection of at least one preferred bill denomination and a quantity of each of the at least one preferred bill denominations. The processing unit is further caused to perform the operation of transmitting a request to automatically disburse from the cash recycler the selected quantity of each of the one or more selected bill denominations.

In another embodiment, a casino cage system includes a processing unit configured to provide cashier transaction options for responding to a request for funds via a graphical-user-interface, the cashier transaction options comprising one or more of cashing a check, cashing casino chips, redeeming a casino ticket, accessing bank account funds, and providing a cash advance. The processing unit is further configured to receive a cashier's selection of one or more of the transaction options, and using the graphical-user-interface, display at least one bill denomination capable of being disbursed using a cash recycler and a quantity of the at least one bill denomination to be disbursed. The processing unit is further configured to receive the cashier's selection of at least one preferred bill denomination and a quantity of each of the at least one preferred bill denominations. The processing unit is further configured to transmit a request to automatically disburse from the cash recycler the selected quantity of each of the one or more selected bill denominations. The casino cage system further includes a cash recycler coupled to the processor, and a display coupled to the processor for providing the graphical-user-interface.

In some embodiments, the system includes a video recorder configured to record operation of the system by the cashier. The system may include a card reader.

### BRIEF DESCRIPTION OF THE DRAWINGS

FIG. 1 is a schematic diagram of the system, according to an embodiment;

FIG. 2 is an exemplary computer system that may be configured to perform any of the processes described herein;

FIG. 3 is a transaction selection screen of a user interface, according to an embodiment;

FIG. 4 is a cash advance screen of a user interface, according to an embodiment;

FIG. 5 is a cash transaction screen, according to an embodiment;

FIG. 6 is a check transaction screen of a user interface, according to an embodiment;

FIG. 7 is a ticket transaction screen of a user interface, according to an embodiment;

FIG. 8 is a chip transaction screen of a user interface, according to an embodiment;

FIG. 9 is a cashier dispense interface, according to an embodiment;

FIG. 10 is a hotkey control interface, according to an embodiment;

FIG. 11 is a transaction receipt, according to an embodiment;

FIG. 12 is an illustration of a dispensing journal, according to an embodiment;

FIG. 13 is an illustration of a dispenser report, according to an embodiment;

FIG. 14 is an illustration of another dispenser report, according to an embodiment;

FIG. 15 is an illustration of a process flow for cashier transaction options, according to an embodiment;

FIG. 16 is an illustration of a process flow of a cash transaction, according to an embodiment;

FIG. 17 is an illustration of a process flow of a check transaction, according to an embodiment;

FIG. 18 is an illustration of a process flow of a ticket transaction, according to an embodiment;

FIG. 19 is an illustration of a chip transaction, according to an embodiment; and

FIG. 20 is an illustration of a cash recycler, according to an embodiment.

### DESCRIPTION OF EXEMPLARY EMBODIMENTS

According to multiple embodiments, the system provides an interface for a casino cashier working in a casino cage. Rather than accessing multiple systems for different types of cash, credit, chip, or check transactions, the system may permit a casino cashier with the option of using a unified system for performing multiple transactions, which can assist with record keeping, efficiency, and security of casino operations. The casino cashier may be required to log into the system to enable additional data collection and security with respect to the transactions that are performed at the casino cage. Such data may include the number of patrons assisted, the cash amounts disbursed, and the types of transactions performed. The system may include options for providing reports on-screen with respect to recent and/or previous transactions performed in connection by the cashier/manager/user.

The system may also collect casino patron information such as name, address, phone numbers, official identification (e.g., driver's license, passport number, green card), and/or hotel/casino membership numbers.

The system may further permit a casino cashier to automate cash dispensing operations by using a cash recycler to automatically dispense the desired funds. The system may automatically determine the types of bills to dispense and/or the system may provide the cashier with options to control selection of bill amounts to be dispensed, as described in greater detail below in connection with the figures.

By collecting information in connection with the cashier and/or patrons while automating cash disbursal and/or other financial transactions, the system may provide greater speed, accuracy, and/or security with respect to cash and other financial transactions involving casino cashiers.

Embodiments of the method may include:
Identifying an account to a terminal
Acquiring authorization for a transaction
Requesting money to be dispensed using cash dispenser
Communication using protocol defined by cash dispenser/cash recycler
Dispensing cash to the penny
   OR
Counting chips presented to a cashier
Invoking software application to receive the count and
Communicating with the dispenser/cash recycler to dispense cash to the penny
   OR
Accepting a personal/business check
Acquiring authorization from the check processing host
Upon receiving authorization, interfacing with the dispenser/cash recycler
Using the dispenser/cash recycler communication protocol to dispense cash to the penny

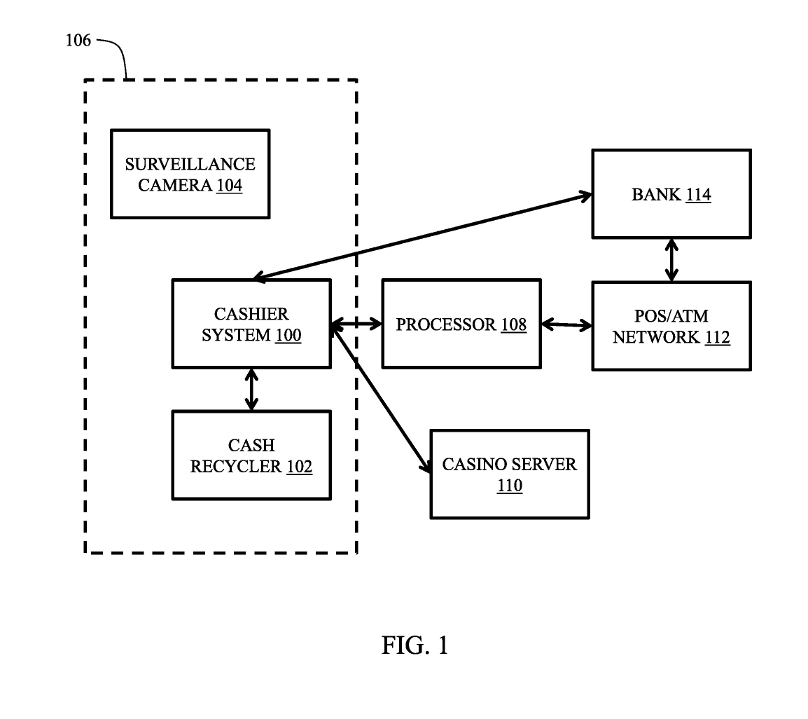

FIG. 1 is a schematic diagram of the system, according to an embodiment. FIG. 1 includes a cashier system 100, a cash recycler 102, a surveillance camera 104, a casino cage 106, a processor 108, a Point Of Sale/Automated Teller Machine (POS/ATM) Network 112, a bank 114, and a casino server 110. The cashier system 100, the cash recycler, and the surveillance camera 104 may each be disposed within the casino cage 106, which may be a centralized enclosure where the records of transactions are kept, money may be counted, and chips or tokens can be purchased or exchanged for cash. The cashier system 100 may include a personal computer, a network computer, a client, or a tablet computer.

The cashier system 100 may communicate with the casino server 110, the processor 108, or directly with a bank 114 to verify that a casino patron is authorized to receive funds. The communication may be accomplished using a direct connection, a local area network, a wide area network, and/or the internet. The processor 108 may communicate with the bank 114 via a POS/ATM network 112, which may include either or both of a POS network and an ATM network.

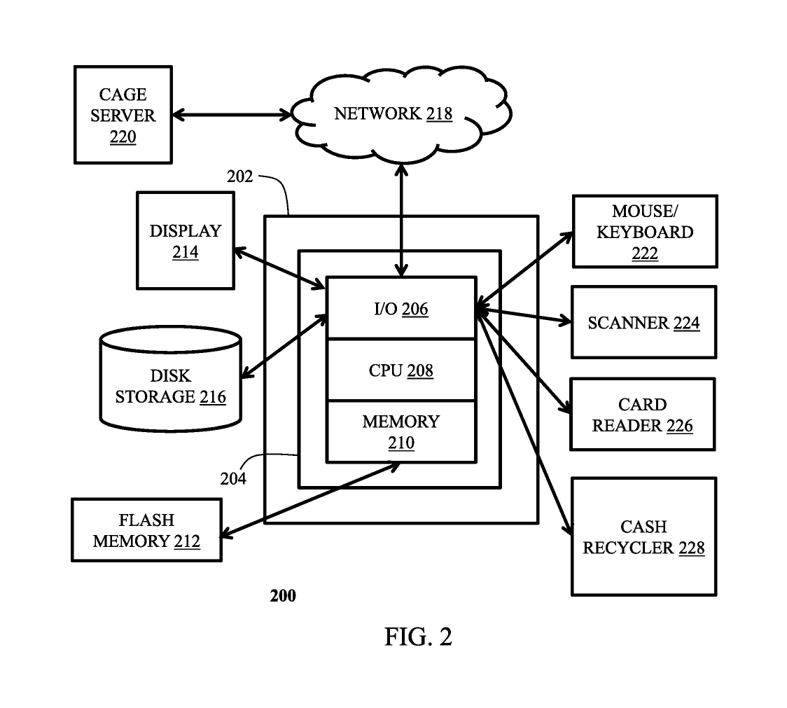

FIG. 2 is an exemplary computer system that may be configured to perform any of the processes described herein. In this context, computing system 200 may include, for example, a processor, memory, storage, and I/O devices (e.g., monitor, keyboard, disk drive, Internet connection, PIN pad, printer, etc.). Computing system 200 may also include circuitry or other specialized hardware for carrying out some or all aspects of the processes. In some operational settings, computing system 200 may be configured as a system that includes one or more units, each of which is configured to carry out some aspects of the processes either in software, hardware, or some combination thereof.

FIG. 2 depicts computing system 200 with a number of components that may be used to perform any of the processes described herein, and may in some embodiments represent the cashier system 100. The main system 202 includes a motherboard 204 having an I/O section 206, one or more central processing units (CPU) 208, and a memory section 210, which may have a flash memory card 212 related to it. The I/O section 206 can be connected to a display 214, a keyboard 222 and/or other user input (e.g., a scanner 224, a card reader 226, a cash recycler 228), and a disk storage unit 216. The scanner 224 may include a bar code scanner, a QR code scanner, an image scanner, an RFID tag reader, a Near Field Communication (NFC) reader, or other input systems. The card reader 226 may include a magnetic stripe reader.

The disk storage unit 216, the memory 210, and/or the flash memory 212 may include a computer-readable medium that can contain programs and/or data. Computing system 200 can include a web browser. Moreover, it is noted that computing system 200 can be configured to include additional systems in order to fulfill various functionalities. In some embodiments, the computer system 200 includes the network 218 and the cage server 220.

At least some values based on the results of the processes described herein can be saved for subsequent use. Additionally, a computer-readable medium can be used to store (e.g., tangibly embody) one or more computer programs for performing any one of the processes described herein by means of a computer. The computer program may be written, for example, in a general-purpose programming language (e.g., Pascal, C, C++, Java, Python) or some specialized application-specific language (PHP, Java Script).

### Transaction Selection

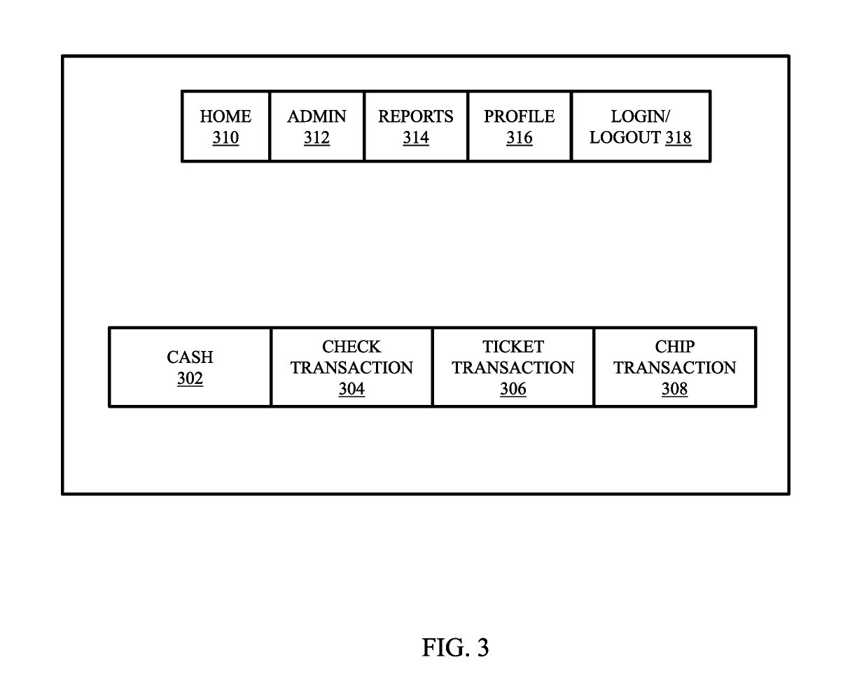

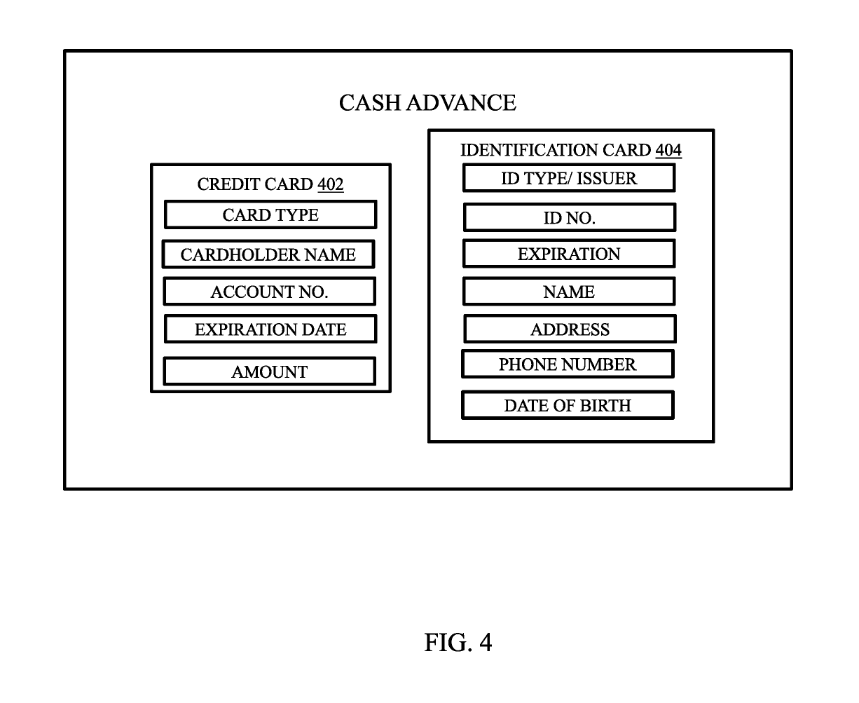

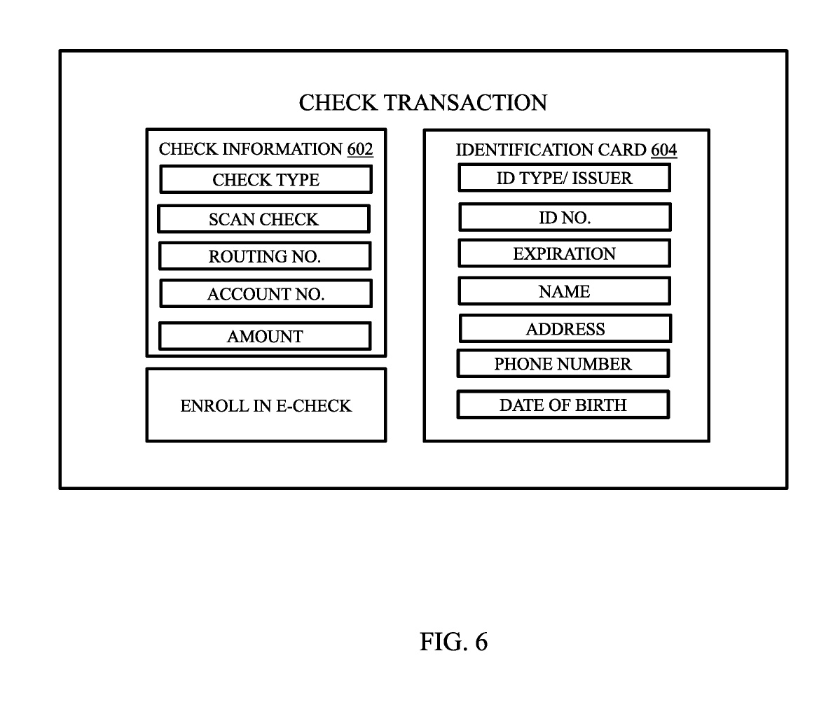

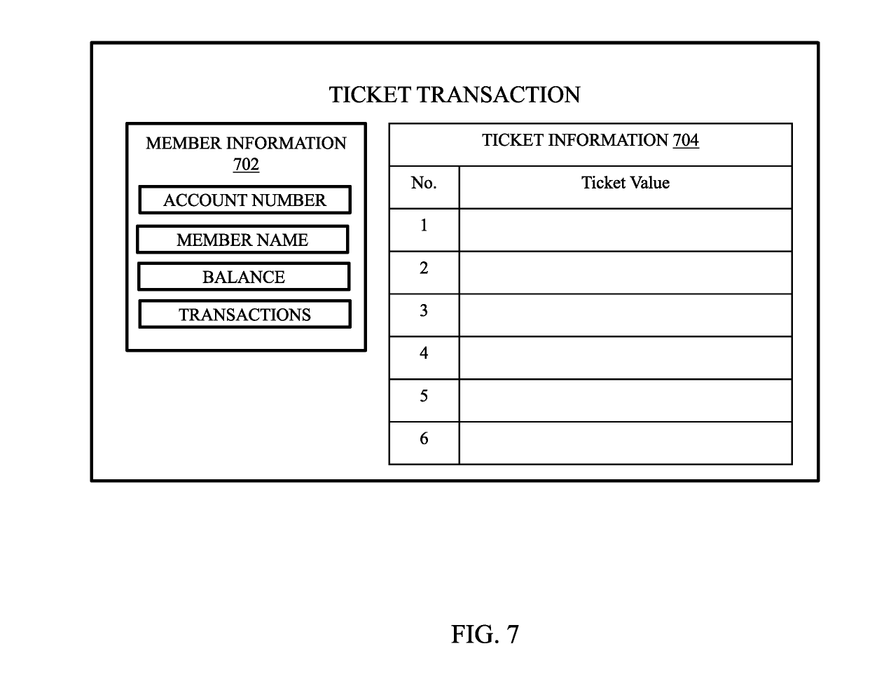

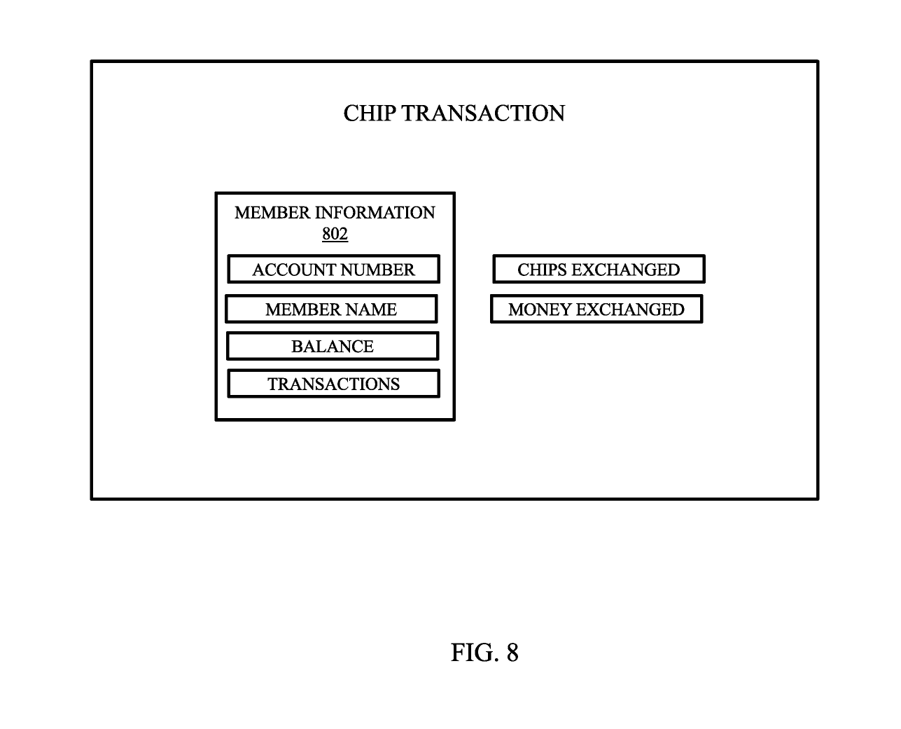

FIG. 3 is a transaction selection screen of a user interface, according to an embodiment. The transaction selection screen may permit a cashier to select between several transactions that may be requested by the casino patron. The transaction selection screen may permit selection of a cash transaction 302, a check transaction 304, a ticket transaction 306, or a chip transaction 308, which are each described in greater detail below. Cash transaction 302 may be associated with the cash advance screen of FIG. 3 and/or the cash transaction screen of FIG. 4. Check transaction 304 may be associated with the check transaction screen of FIG. 6, and ticket transaction 306 may be associated with the ticket transaction screen of FIG. 7. Chip transaction 308 may be associated with the chip transaction screen of FIG. 8.

The transaction selection screen may further include options including: home 310, admin 312, reports 314, profile 316, and login/logout 318. Home 310 may permit the cashier or other user to return to the initial screen of FIG. 3, where different transactions may be selected. Admin 312 may permit the cashier to access administrative options for transactions that may be performed, connected machines, and data collection settings.

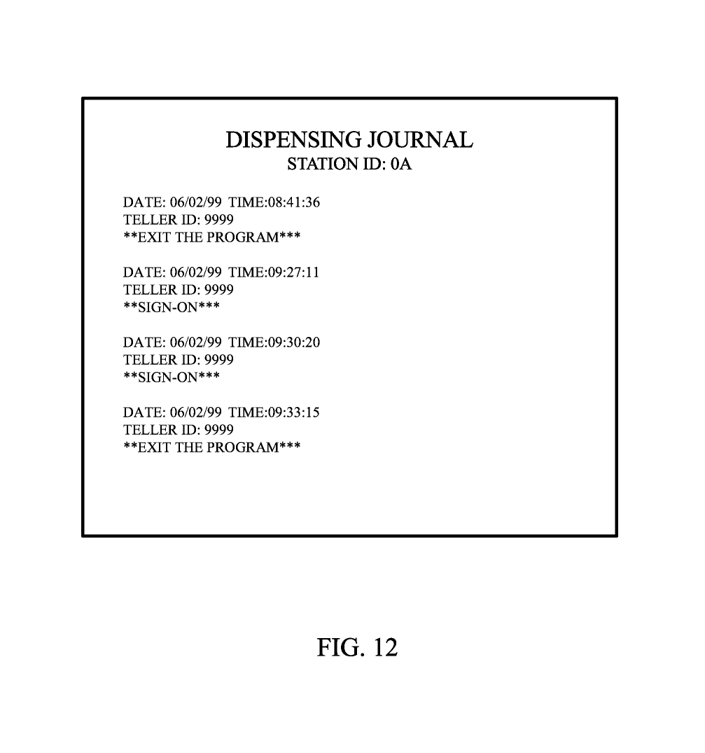

Reports 314 may permit a cashier to generate a report such as a cashier audit report, a daily balancing report, or a dispensing journal (e.g., the reports shown in FIGS. 12-14). The cashier audit report may provide summary and analysis of transactions performed by a cashier, and may be organized by such factors as transaction type, customer identification, date of transactions, and/or size of transaction. The daily balancing report may permit a cashier or other user to provide a report of all transactions performed during the day, including the total amount of cash, checks, chips, or other transactions that were received and/or disbursed in connection with a connected cash recycler 228.

Profile 316 may permit modification of the attributes (e.g., name, age, appearance, etc.) associated with the cashier using the system. Login/logout 318 may permit a cashier to login or logout of the system.

### Selection of a Cash Transaction

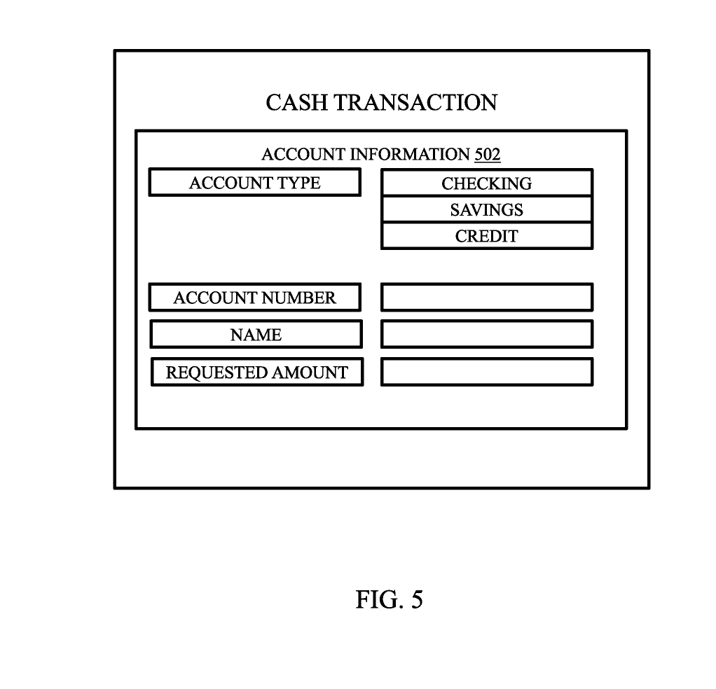

If cash transaction 302 is selected from FIG. 3, the cash advance screen of FIG. 4 and/or the cash transaction screen of FIG. 5 may be presented to the cashier via a user interface. As shown in FIG. 4, the cash advance screen may include a credit card 402 section and an identification card 404 section, which may each include data that is obtained from an input device that obtains the information from a magnetic stripe, RFID tag, barcode, QR code, identification image, and/or Near Field Communication (NFC) systems on a card or smartphone. The system may use one or more input devices such as the mouse/keyboard 222, the scanner 224, and/or the card reader 226 to automatically acquire the information for the credit card section 402 and/or the identification card 404 section. The surveillance camera 104 may be used to visually verify the information printed on a card or displayed on a screen with the information obtained via the input device. Alternatively, the cashier may manually input the information for the credit card 402 section and the identification card 404 section.

The system may require acquisition of both credit and identification information prior to disbursing cash to provide greater security for transactions. The system may further record the casino patron's appearance at the time of the transaction and/or any image of the casino patron provided on an identification card.

As shown in FIG. 5, the system may permit a cashier to provide access to a casino patron's casino, bank, and/or credit account(s). For example, as shown on FIG. 5, the system may receive account information 502, and permit selection of an account type such as: checking, savings, or credit. The system may acquire the account number, the patron's name, and the requested amount either automatically or via manual entry by cashier. Automatic entry of the identification information may be acquired via the scanner 224 or the card reader 226. Alternatively, the information may be acquired directly from the bank 114 based on information provided by the casino patron requesting access to funds.

### Selection of a Check Transaction

The check transaction screen of FIG. 6 includes a check information 602 section and an identification card 604 section. As in the cash advance and/or cash transaction options, the information for the identification card 604 section may be automatically acquired using an input device (e.g., the scanner 224 and/or the card reader 226) or manually entered by the cashier.

The check information 602 section may be filled out automatically using data acquired through an input device (e.g., the scanner 224), which may be triggered by the selection of the “scan check” option. Alternatively, the information may be manually entered using the mouse/keyboard 222 by the cashier or another user. The information may include check type, routing number, account number, and the amount to be disbursed. The check cashing interface may include hotkey options for cancelling the transaction and/or submitting the transaction.

Prior to performing a check transaction, the system may require information for the identification card 604 section, such as ID type and/or issuer, ID number, expiration date, name, address, phone number, date of birth, social security number and/or tax ID.

In some embodiments, the check transaction screen of FIG. 6 may further be used to enroll the casino patron in an e-check program by collecting information related to the user's identity and bank accounts. Once enrolled, the casino patron may be able to perform e-check transactions at the casino cage using government issued identification information and/or casino membership information without a physical check and without requiring additional verification of account number, routing number, and bank information.

### Selection of a Ticket Transaction

The ticket transaction screen of FIG. 7 includes member information 702 and ticket information 704. The data for both sections may be acquired automatically via an input device or manually entered by the cashier.

If the casino patron is also registered as a member with the casino system, the casino system may already have the casino patron's name associated with an account number, an account balance, and transaction history. The member information 702 may include account number, member name, balance, and transactions.

The ticket information 704 may include information from multiple tickets to be grouped together as one disbursal. Each ticket may include the identification of the machine and time that the ticket was provided as well as the amount to be disbursed. Tickets may be provided by ATM machines or slot machines. The amount to be provided may be verified by the ticket number and member information such as the member's account number, name, or other identifying information. The ticket may include a barcode or QR code that may be scanned.

### Selection of a Chip Transaction

FIG. 8 illustrates a chip transaction screen, according to an embodiment. The chip transaction screen may record member information associated with the chip transaction such as account number, member name, balance, and transactions. The member information may include the member's account number, name, account balance, and transaction history.

The chip transaction interface may permit exchange of chips for cash, or vice versa. When cash is provided by a casino patron to be exchanged for ships, the chip transaction interface may permit the cashier to manually enter the amount of money provided. Alternatively, the cash recycler may automatically count and/or verify the amount of cash provided by the casino patron. Each bill provided by the casino patron may be displayed by the cashier to the surveillance camera 104 and/or the scanner 224 to assist with resolving disputes.

When a casino patron provides chips to be exchanged for cash, the chips may be displayed for verification to the surveillance camera 104 and/or the scanner 224. The cashier may manually count the chips to be exchanged and enter the total dollar value of the chips to be exchanged for cash. The system may include a user interface with predetermined chip denominations (not shown) that permits a cashier to enter the quantity of each type of chip being exchanged for cash. Alternatively, the system may automatically count and display the quantity of each chip being exchanged for cash.

### Cash Dispensing

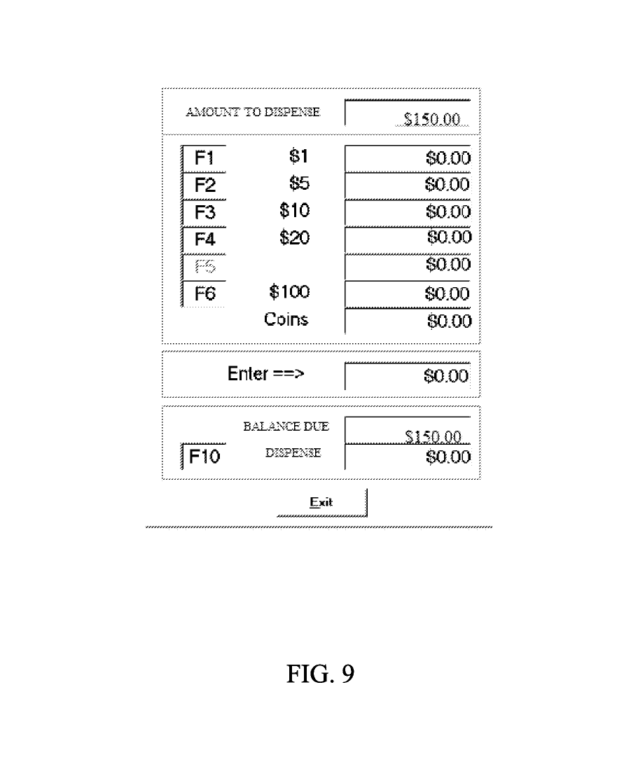

For each transaction involving disbursing cash, the cashier may be presented with an interface for selecting bill denominations as shown in FIG. 9. The amount to be dispensed may be manually entered or automatically determined, such as from a ticket with a pre-authorized cash value, an automatically scanned check, or an automatically counted set of chips. The cashier may be able to modify the amount to be dispensed, or the total may be fixed.

In some embodiments, the system may select the bills used to satisfy the amount according to an algorithm, such as selecting the least number of bills possible to satisfy the amount, or by using a preferred denomination such as all $20 bills, or all $50 bills. Alternatively, the system may start with no bills designated, and allow the cashier to increment or decrement the number of a particular type of bill by pressing a key or a combination of keys. The system may display a cash value of the bills used to satisfy the amount to be disbursed. In addition, the system may display a quantity of each bill to be disbursed via the cash recycler 228.

For example, if a cashier (or other user) wishes to increase the number of bills by one, they may push “F1” to increase the number of $1 bills disbursed, or “F2” to increase the number of $5 bills disbursed. The system may be configured to decrease the number of $1 bills disbursed by one each time “F1” is pushed in combination with a “control” key, and to decrease the number of $5 bills by one each time “F2” is pushed in combination with the “control” key. Other hotkeys such as “1,” “2,” or “3” may be used to designate orders of magnitude, such that pressing “1” plus the “F1” key increments the number of $1 bills by 10, and pressing “2” plus the “F1” key increments the number of $1 bills by 100.

In some embodiments, “m” may be used to designate the maximum number of bills possible of a particular denomination. For example, pressing “m” and “F1” may designate one hundred fifty $1 bills to satisfy the $150 amount. Alternatively, pressing “m” and “F3” may designate fifteen $10 bills to satisfy the $150 amount.

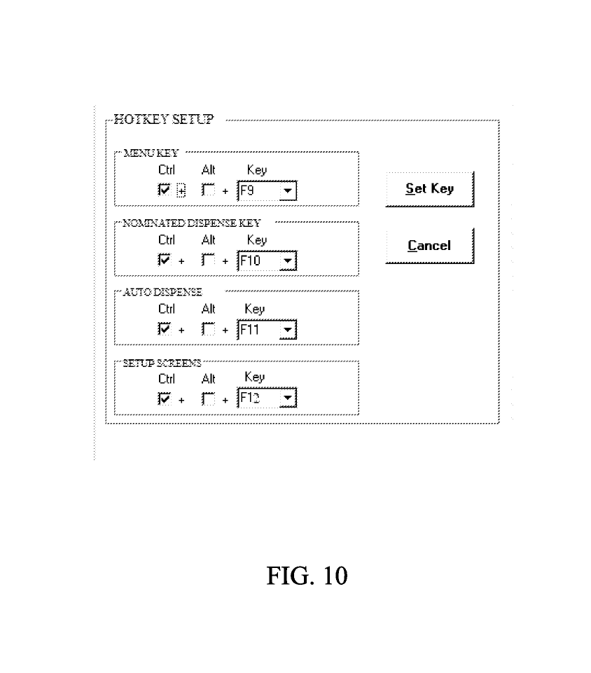

FIG. 10 is an illustration of a user interface for customizing hotkey combinations, such as for returning to a main menu, providing a nominated dispense (e.g., one bill to be dispensed is increased with each key press), automatically determining the mix of bill types to be dispensed, or accessing the hotkey setup screens.

### Transaction Records and Reporting

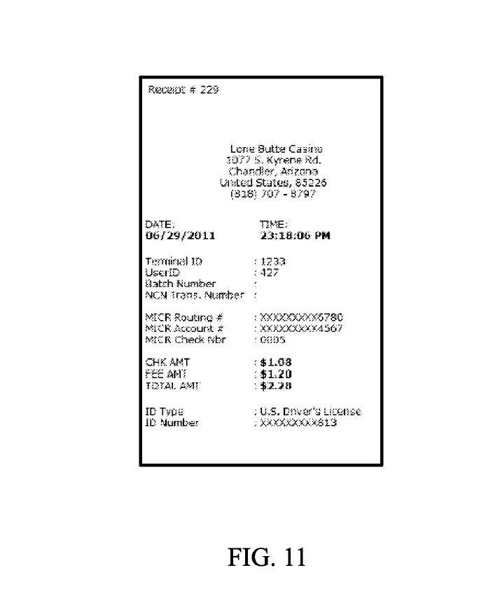

A net amount of each denomination may be tracked in real time with each transaction performed by specific tellers using the machine. After each transaction, the casino patron may be provided with a physical receipt, such as the example shown in FIG. 11. The system may generate a duplicate copy for casino records. The receipt may include a receipt number, identification information for the casino such as address, name and phone number, the date of the transaction, and the amount provided and/or received. The Receipt may further indicate the terminal used to perform the transaction, and a cashier identification number. Where applicable, the receipt may include a batch number, an NCN transaction number, any applicable MICR Routing number, any applicable MICR Account number, any applicable MICR check number, a check amount, a fee amount, and a total amount. The receipt may further indicate an identification type and identification number. The identification number may be obscured to protect the casino patron's privacy.

FIG. 12 is an illustration of a dispensing journal, according to an embodiment. When a cashier uses the system to perform a transaction, a dispensing journal may be updated that identifies the date and time for the transaction, the user identification of the cashier using the system, the transaction that occurred, and the product that was used to dispense the cash.

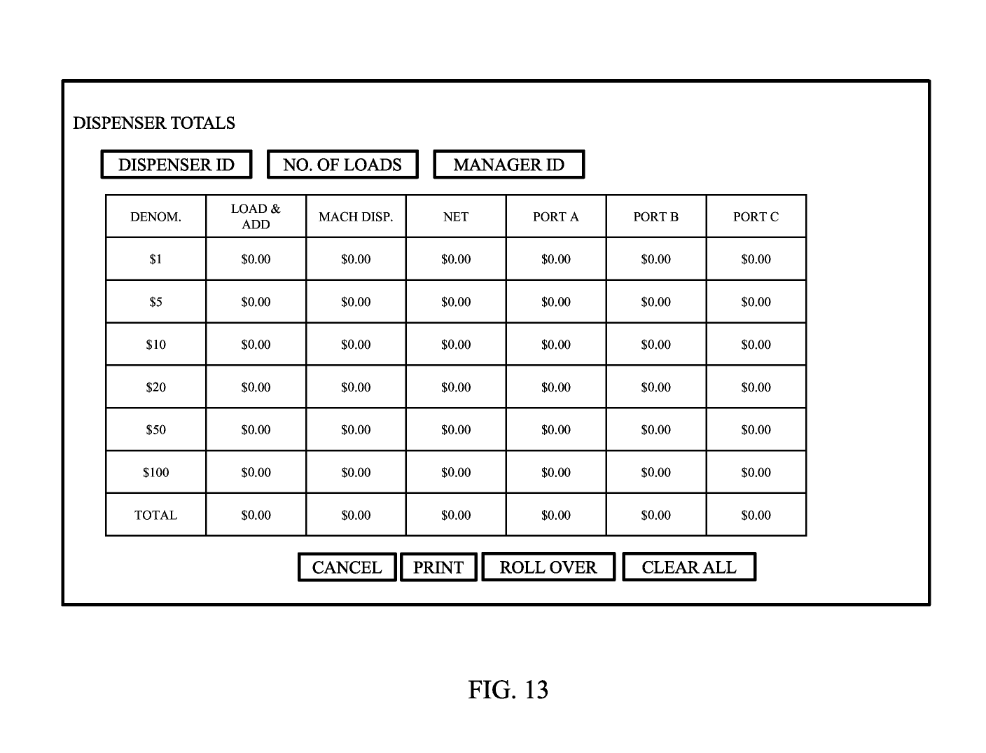

FIG. 13 is an illustration of a dispenser report, according to an embodiment. The system may maintain a record of dispenser totals for each denomination, amounts added, amounts dispensed, the net amount, and the totals accessible from different ports (e.g., port A, port B, port C). Reports generated by the system may include dispenser identification, the number of loads added to the machine, and a manager. The system may allow reports to be generated, cancelled, printed, rolled over, or cleared. The daily rollover may be an amount that is cleared at the end of each day to permit a new day to be started.

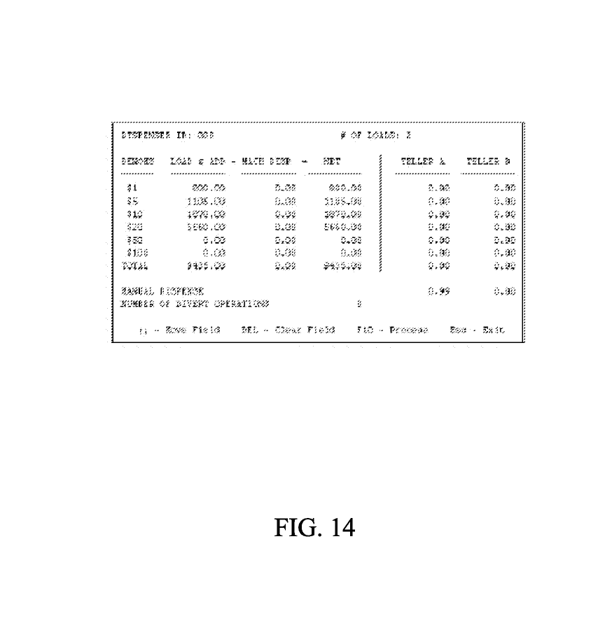

FIG. 14 is an illustration of another dispenser report, according to an embodiment. As shown in FIG. 14, the report may identify amounts for individual bill denominations and totals for cash manually dispensed by different tellers using the same terminal. The dispenser report may be a daily rollover report that provides cash in, cash out, denomination added, remaining balance, and a cashier name. The dispenser report may also include an audit history, and may permit a manager to move fields, clear fields, process the report, or exit the system.

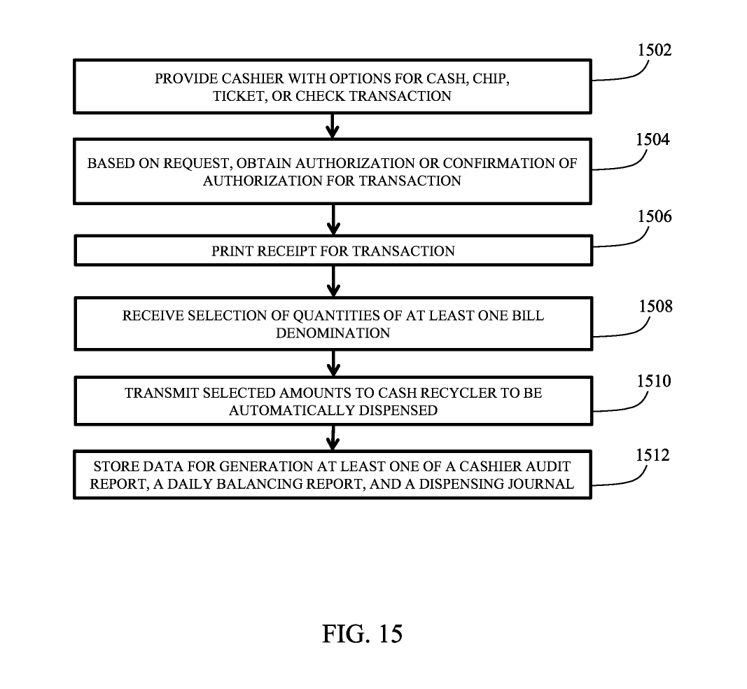

FIG. 15 is an illustration of a process flow for selection and performance of cashier transaction options using the system, according to an embodiment. In operation 1502, the system may provide a cashier with options for a cash, chip, ticket, or check transaction. For example, the cashier system 100 may display the interface of FIG. 3 to a cashier via the display 214.

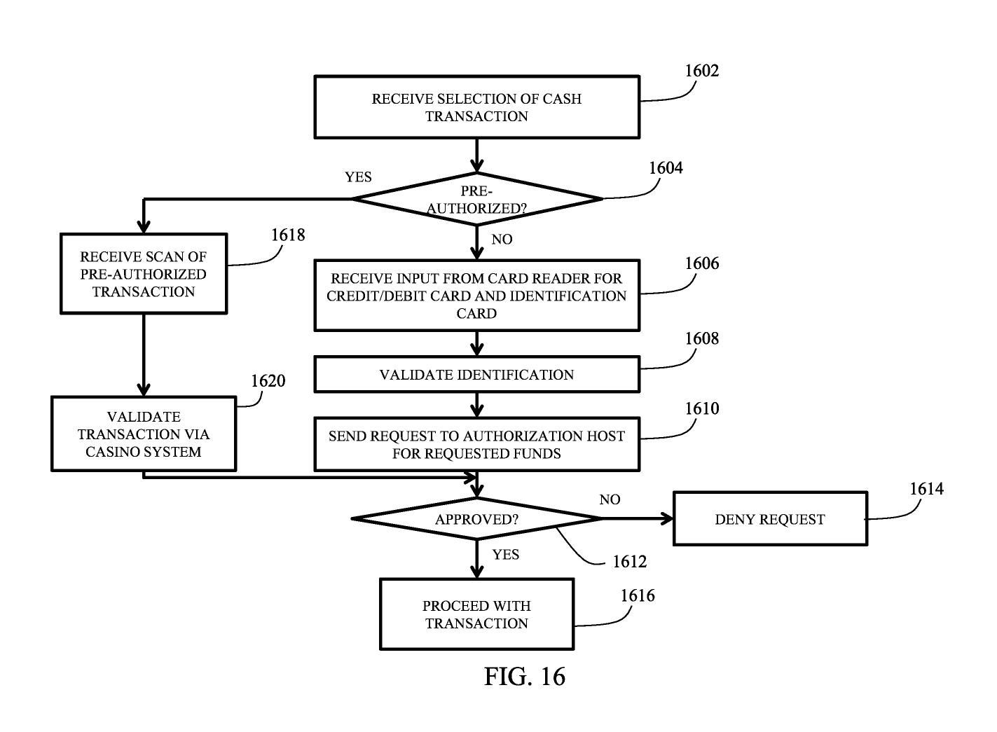

In operation 1504, the system may, based on a request, obtain authorization or confirmation of authorization for a transaction. The system may receive the cashier's selection of a transaction option via a mouse-click on the appropriate icon in the graphical-user-interface of FIG. 3, or via a keyboard selection that permits highlighting the correct option, or via a hotkey assigned to a particular option. The procedures for obtaining authorization may be described in greater detail in FIGS. 16-19.

In operation 1506, the system may print a receipt for the transaction, such as the receipt shown in FIG. 11. In operation 1508, the system may receive the cashier's selection of quantities of at least one bill denomination. For example, the CPU 208 may receive the cashier's selection of differing bill amounts to be disbursed via the interface of FIG. 9, as described above.

In operation 1510, the system may transmit selected amounts to cash recycler to be automatically dispensed. For example, the CPU 208 may transmit commands via the I/O 206 to be received by the cash recycler 228 to dispense the amounts of each bill type indicated by the cashier and/or that were automatically selected.

In operation 1512, the system may store data for generation of at least one of a cashier audit report, a daily balancing report, and a dispensing journal. For example, the CPU 208 may store the data utilized in any or all of FIGS. 4-8 and 12-14, such as credit card 402 information, identification card 404 information, account information, check information 602, member information 702, ticket information 704, chip transaction information. In addition, the system may store information such as amounts of each bill type dispensed or received, amounts of each chip type dispensed or received, hotkeys pressed by the cashier, transaction options selected by the cashier, reports generated, access by cashiers, managers, or other users, and print, roll over, or clear commands.

### Obtaining Authorization for Transactions

Operations for obtaining authorization for various types of transactions are described in greater detail in FIGS. 16-18.

FIG. 16 is an illustration of a process flow of a cash transaction, according to an embodiment. In operation 1602, the system may receive selection of a cash transaction. For example, the CPU 208 may receive the cashier's selection of cash transaction 302. In operation 1604, the system may determine whether the cash transaction is preauthorized. As part of operation 1604, the CPU 208 may request an indication (e.g., via a pop-up window) from the cashier whether the transaction is pre-authorized by the casino. For example, a casino patron may make an ATM transaction and receive a ticket to be redeemed by a casino cashier. Alternatively, a casino patron may gamble and receive a ticket for funds that were won. If the transaction was pre-authorized, the process may continue with operation 1618, otherwise the process may continue with operation 1606.

In operation 1606, the system may receive input from a card reader for a credit/debit card and an identification card. The system may prompt the casino cashier to obtain card scans for both the credit/debit card as well as the user's identification card (e.g., a driver's license, a passport, a license, or other government issued identification).

In operation 1608, the system may validate the user's identification. For example, the CPU 208 or the cage server 220 may transmit information from the casino patron's identification to the casino server 110, the processor 108, or the bank 114 to verify that the identification exists and/or that the identification card is genuine.

In operation 1610, the system may send a request to an authorization host for the requested funds. In an embodiment, the cashier system 100 transmits a request to the processor 108 to be relayed via the POS/ATM network 112 to the bank 114 to obtain authorization for disbursing funds. The authorization host may be operated by the processor 108 or the bank 114. In some embodiments, the cashier system 100 (e.g., the CPU 208, the I/O 206, the cage server 220) may send the request directly to the bank 114 rather than through the processor 108.

In operation 1612, if the transaction is approved, the process may proceed with the transaction in operation 1616 (e.g., the process may continue with operation 1506). Otherwise, the request may be denied in operation 1614.

If the transaction was pre-authorized, in operation 1618, the system may receive a scan of the pre-authorized transaction (e.g., via a printed ticket, a ticket displayed on a smartphone screen, an emailed ticket, a ticket provided via SMS, a barcode, a QR code, an RFID communication, or an NFC communication).

In operation 1620, the transaction may be validated via the casino system. For example, the scanned information may be provided by the CPU 208 to the cage server 220 or the casino server 110 to be compared to stored records. In other embodiments, the CPU 208 or the cage server 220 transmits the identification information to the processor 108 and/or the bank 114 to be validated. From operation 1620, the process continues with operation 1612 as described above.

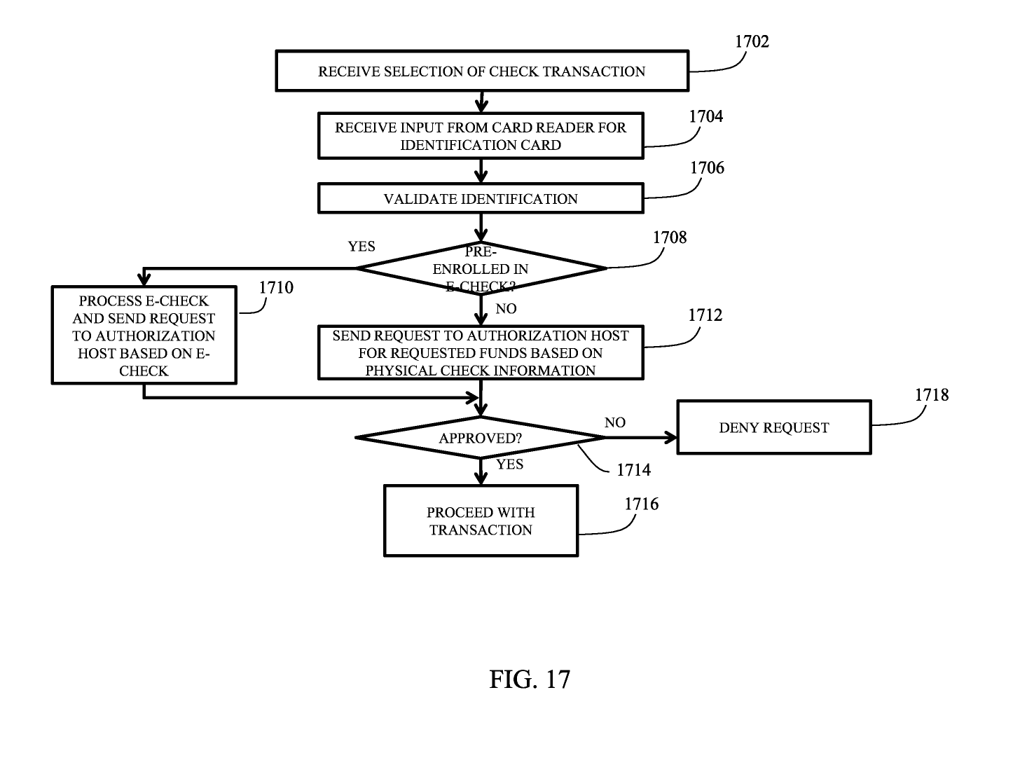

FIG. 17 is an illustration of a process flow of a check transaction, according to an embodiment. In operation 1702, the system may receive selection of check transaction 304 via the user interface of FIG. 3. For example, the CPU 208 may receive the cashier's selection of check transaction 304 via a mouse/keyboard 222 input or a touchscreen input.

In operation 1704, the system may receive input from the card reader 226 for a casino patron's identification card. In other embodiments, the scanner 224 may be used to acquire information as discussed above.

In operation 1706, the system may validate the casino patron's identification by comparing the scanned information with casino records and/or with third party databases or validation systems.

In operation 1708, the system may determine whether the casino patron is enrolled in an e-check program.

If the casino patron is enrolled in the e-check program, in operation 1710, the system may process the e-check and send a request to an authorization host based on the e-check. The authorization host may be operated by the processor 108, or the bank 114. The request may be processed via the Automated Clearing House (ACH) Network and may involve transmission of a bank account number and routing number. A flat rate may be charged for processing the e-check payment, which may be lower than the cost associated with processing a credit card payment.

In operation 1714, if the transaction is approved, the transaction may proceed in operation 1716 (e.g., the process may return to operation 1506 of FIG. 15). If the transaction is not approved, the transaction may be rejected in operation 1718.

If the casino patron is not enrolled in an e-check program, the n operation 1714, the system may send a request to the authorization host for requested funds based on the physical check information, including routing number and account number. The process then proceeds to operation 1714, as described above.

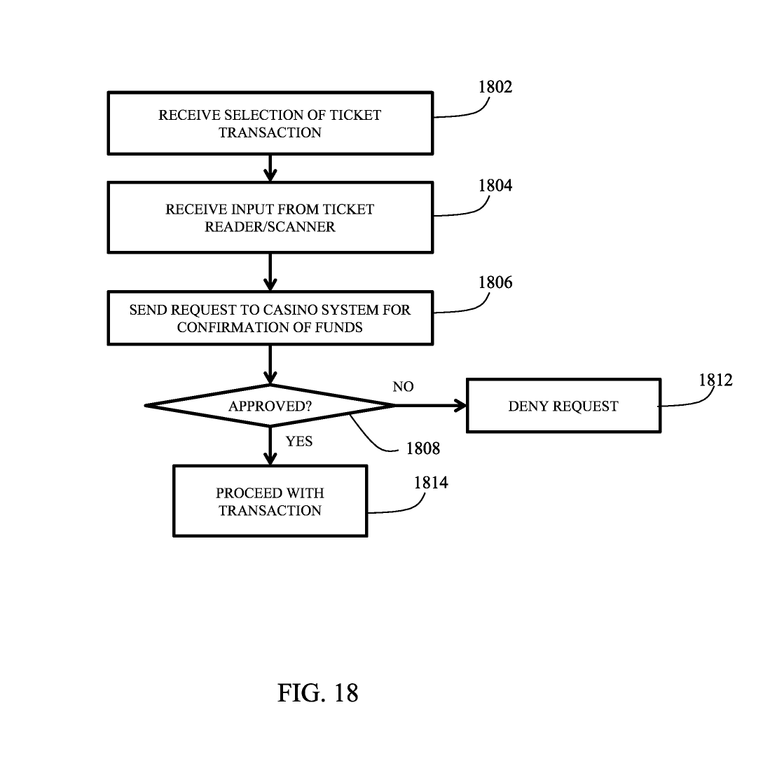

FIG. 18 is an illustration of a process flow of a ticket transaction, according to an embodiment. In operation 1802, the system may receive selection of ticket transaction 306 via the user interface of FIG. 3. For example, the CPU 208 may receive the cashier's selection of ticket transaction 306 via a mouse/keyboard 222 input or a touchscreen input.

In operation 1804, the system may receive input from a ticket reader, such as the scanner 224. The scanner may be configured to read bar codes, QR codes, magnetic information, RFID tags, NFC communications, Bluetooth signals, or other systems for conveying information. The information may include any of the data described with respect to FIGS. 4-8 and 11-14.

In operation 1806, the system may transmit the information to the casino system for confirmation of funds. For example, the CPU 208 and/or the cage server 220 may transmit the information obtained from the ticket (including the amount to be disbursed) to the casino server 110 to be compared with stored information.

In operation 1808, the system may determine whether the request should be approved or denied. For example, the system may determine whether the ticket accurately describes a transaction that took place or was authorized via a casino slot machine or ATM machine. The request may be authorized in operation 1814 if the ticket information (e.g., name, date, amount disbursed) matches the stored information. If the ticket information does not match the stored information, the request may be denied in operation 1812.

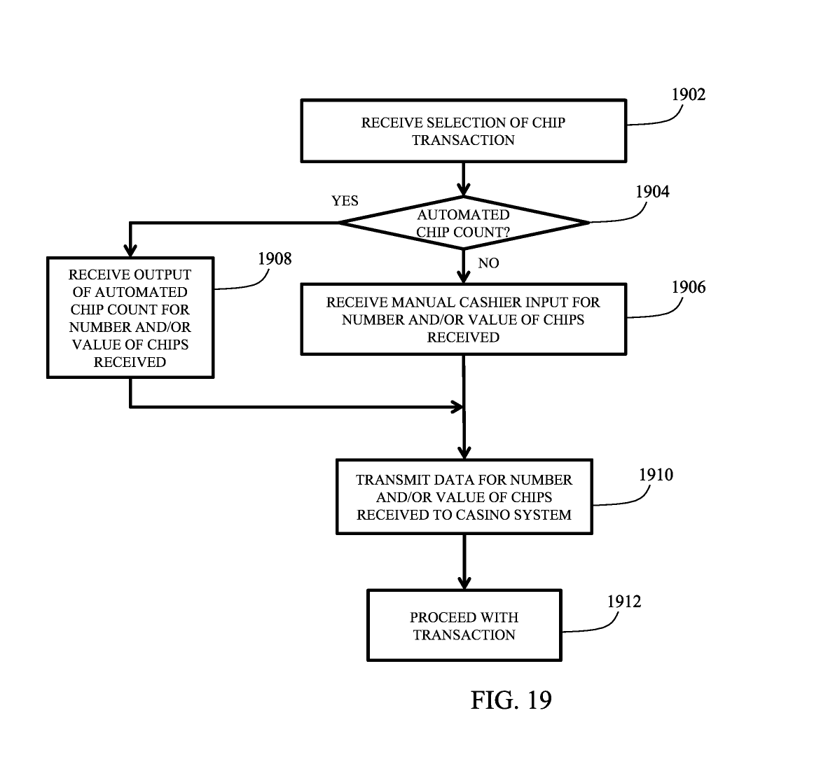

FIG. 19 is an illustration of a chip transaction, according to an embodiment. In operation 1902, the system may receive selection of chip transaction 308 via the user interface of FIG. 3. For example, the CPU 208 may receive the cashier's selection of chip transaction 308 via a mouse/keyboard 222 input or a touchscreen input.

In operation 1904, if an automated chip counter is available, the system may proceed to operation 1908. Otherwise, the process may continue with operation 1906, in which the system receives cashier input regarding chip quantities in different denominations that were manually counted and received by the cashier.

In operation 1908, the system receives the output of an automated chip counter for the number and/or value of chips received.

From either operation 1906 or 1908, the process continues with operation 1910, in which the data for the number and/or value of received chips is transmitted to the casino system (e.g., the casino server 110 and/or the cage server 220).

In operation 1912, the system may proceed with the transaction (e.g., disbursing funds and tracking transaction data in accordance with FIG. 15

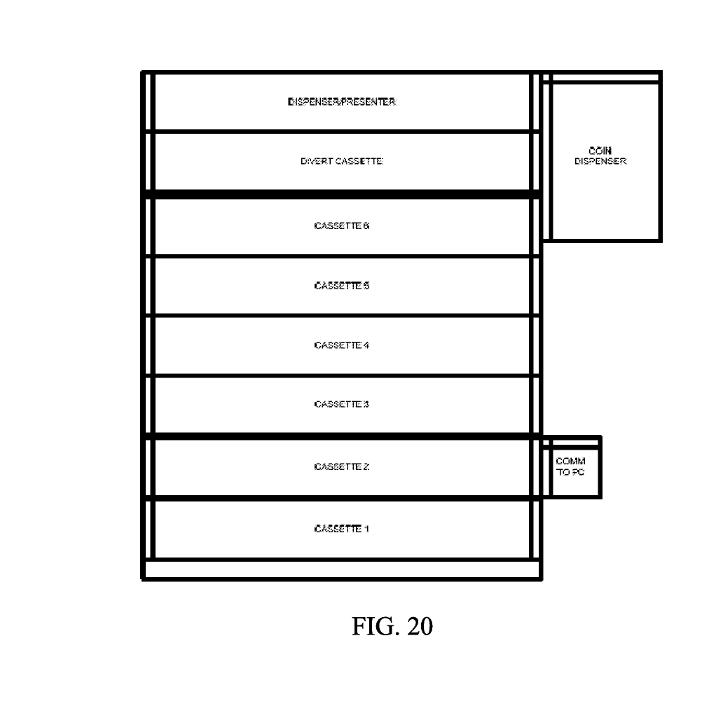

FIG. 20 is an illustration of a cash recycler 228, according to an embodiment. Components of the cash recycler 228 include a dispenser/presenter, a divert cassette, a coin dispenser, a communication to PC interface, and multiple cassettes 1-6.

Although the invention has been described using specific terms, devices, and/or methods, such description is for illustrative purposes of the preferred embodiment(s) only. Changes may be made to the preferred embodiment(s) by those of ordinary skill in the art without departing from the scope of the present invention, which is set forth in the following claims. In addition, it should be understood that aspects of the preferred embodiment(s) generally may be interchanged in whole or in part.

What is claimed is:

1. A casino cage method, comprising:
using a processing unit, providing cashier transaction options for responding to a request for funds via a graphical-user-interface, the cashier transaction options comprising one or more of cashing a check, cashing casino chips, redeeming a casino ticket, accessing bank account funds, and providing a cash advance;
receiving a cashier's selection of one or more of the transaction options;
using the graphical-user-interface, displaying at least one bill denomination capable of being disbursed using a cash recycler and a quantity of the at least one bill denomination to be disbursed;
receiving the cashier's selection of at least one preferred bill denomination and a quantity of each of the at least one preferred bill denominations;
transmitting a request to automatically disburse from the cash recycler the selected quantity of each of the one or more selected bill denominations.

2. The method of claim 1, further comprising
verifying authorization to transfer funds when the selected transaction option is one of cashing a check, redeeming a casino ticket, and obtaining a cash advance.

3. The method of claim 1, further comprising
logging transactions performed using the system with respect to a login identifier; and
generating a report of transactions performed with respect to the login identifier.

4. The method of claim 1, wherein the cashier transaction options include each of cashing a check, cashing casino chips, redeeming a casino ticket, accessing bank account funds, and providing a cash advance.

5. The method of claim 1, further comprising:
generating a proposed quantity of bill denominations to fulfill the request for funds in accordance with a predetermined function.

6. The method of claim 3, wherein the predetermined function comprises one of using the least number of bills capable of fulfilling the request for funds,
providing a requested quantity of a preferred bill denomination and automatically selecting a remaining set of bills to minimize the number of bills disbursed, and
using the least number of bills available in the cash recycler to satisfy the request for funds.

7. The method of claim 1, further comprising
receiving a customer's identification number from a card reader; and
logging transactions performed using the system with respect to the customer's identification number and the login identifier.

8. The method of claim 1, further comprising
video recording operations performed by a cashier while using the system.

9. The method of claim 1, wherein a hotkey is assigned to a particular bill denomination, and where the cashier selection of a bill denomination is received after the hotkey is pressed.

10. The method of claim 9, wherein the quantity of the selected bill denomination to be disbursed corresponds to the number of times the hotkey is pressed.

11. The method of claim 9, wherein the quantity of the selected bill denomination to be disbursed is selected using numeric key entries after the bill denomination has been selected.

12. A computer-readable medium including instructions that, when executed by a processing unit, cause the processing unit to performing the operations of:
using a processing unit, providing cashier transaction options for responding to a request for funds via a graphical-user-interface, the cashier transaction options comprising one or more of cashing a check, cashing casino chips, redeeming a casino ticket, accessing bank account funds, and providing a cash advance;
receiving a cashier's selection of one or more of the transaction options;
using the graphical-user-interface, displaying at least one bill denomination capable of being disbursed using a cash recycler and a quantity of the at least one bill denomination to be disbursed;
receiving the cashier's selection of at least one preferred bill denomination and a quantity of each of the at least one preferred bill denominations;
transmitting a request to automatically disburse from the cash recycler the selected quantity of each of the one or more selected bill denominations.

13. The computer-readable medium of claim 12, further comprising instructions that, when executed by the processing unit, cause the processing unit to perform the operation of:
verifying authorization to transfer funds when the selected transaction option is one of cashing a check, redeeming a casino ticket, and obtaining a cash advance.

14. The computer-readable medium of claim 12, further comprising instructions that, when executed by the processing unit, cause the processing unit to perform the operation of:
logging transactions performed using the system with respect to a login identifier; and
generating a report of transactions performed with respect to the login identifier.

15. The computer-readable medium of claim 12, wherein the cashier transaction options include each of cashing a check, cashing casino chips, redeeming a casino ticket, accessing bank account funds, and providing a cash advance.

16. The computer-readable medium of claim 12, further comprising instructions that, when executed by the processing unit, cause the processing unit to perform the operation of:
generating a proposed quantity of bill denominations to fulfill the request for funds in accordance with a predetermined function.

17. The computer-readable medium of claim 16, wherein the predetermined function comprises one of
using the least number of bills capable of fulfilling the request for funds,
providing a requested quantity of a preferred bill denomination and automatically selecting a remaining set of bills to minimize the number of bills disbursed, and
using the least number of bills available in the cash recycler to satisfy the request for funds.

18. A casino cage system, comprising:
a processing unit configured to
provide cashier transaction options for responding to a request for funds via a graphical-user-interface, the cashier transaction options comprising one or more of cashing a check, cashing casino chips, redeeming a casino ticket, accessing bank account funds, and providing a cash advance;
receive a cashier's selection of one or more of the transaction options;
using the graphical-user-interface, display at least one bill denomination capable of being disbursed using a cash recycler and a quantity of the at least one bill denomination to be disbursed;
receive the cashier's selection of at least one preferred bill denomination and a quantity of each of the at least one preferred bill denominations;
transmit a request to automatically disburse from the cash recycler the selected quantity of each of the one or more selected bill denominations.
a cash recycler coupled to the processor; and
a display coupled to the processor for providing the graphical-user-interface.

19. The system of claim 18, further comprising a video recorder configured to record operation of the system by the cashier.

20. The system of claim 19, further comprising a card reader.
